(19) United States
(12) Patent Application Publication
(10) Pub. No.: US 2026/0244491 A1
(43) Pub. Date: Aug. 20, 2026

(54) COMPUTER-READABLE RECORDING MEDIUM HAVING STORED THEREIN INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Yoshifumi UJIBASHI, Kawasaki (JP)

(73) Assignee: Fujitsu Limited, Kawasaki-shi (JP)

(21) Appl. No.: 19/541,458

(22) Filed: Feb. 17, 2026

(30) Foreign Application Priority Data
Feb. 20, 2025 (JP) 2025-026171

(51) Int. Cl. G06F 9/48; G06F 9/50

(52) U.S. Cl. CPC G06F 9/4881; G06F 9/4887; G06F 9/5038

(57) ABSTRACT

A non-transitory computer-readable recording medium having stored therein an information processing program that causes a computer to perform a process including; managing a first memory and a second memory as a single integrated memory, predicting, when a second calculation resource executes a target process, a first predicted end time for a first method in which the process is allocated beyond the capacity of the second memory and a second predicted end time for a second method in which the process is allocated with a delay so as not to exceed that capacity, and to execute the target process using whichever of the first or second method provides higher processing performance based on the predicted end times.

### CROSS-REFERENCE TO RELATED APPLICATION

This application is based upon and claims the benefit of priority of the prior Japanese Patent application No. 2025-26171, filed on Feb. 20, 2025, the entire contents of which are incorporated herein by reference.

### FIELD

The present embodiment relates to a computer-readable recording medium having stored there in an information processing program, an information processing apparatus, and an information processing method.

### BACKGROUND

It is known that using a graphics processing unit (GPU) instead of a central processing unit (CPU) for executing deep learning applications (hereinafter, referred to as “deep learning apps”) improves processing performance (see, for example, Patent Document 1).

In addition, the rapid advancement of AI in recent years has led to rising GPU prices and supply shortages. Therefore, there is a demand for executing a plurality of artificial intelligence (AI) processes with a small number (for example, one) of GPUs, that is, for executing a plurality of deep learning apps.

However, when the AI processing is executed by multiple users or multiple processes, an out of memory (OOM) occurs with high probability.

As a technique for suppressing the occurrence of the OOM, for example, a CUDA® unified memory (Unified memory) of Nvidia® is known (CUDA is registered trademark).

The CUDA unified memory is a technology that enables a memory (system memory) used by a central processing unit (CPU) and a memory equipped with a GPU (hereinafter, the memory may be referred to as a GPU memory) to be accessed in a single memory space. As a result, the memory of physically separate CPU and GPU memory can be treated as one integrated memory, and the occurrence of the OOM can be suppressed.

For example, related arts are disclosed in Japanese Laid-open Patent Publication No. 2022-124765(Patent Document 1), Japanese Laid-open Patent Publication No. 2004-252983(Patent Document 2), US Patent Application Publication No. 2024/0211307(Patent Document 3) and US Patent Application Publication No. 2016/0103715 (Patent Document 4).

### SUMMARY

According to an aspect of the embodiment, a non-transitory computer-readable recording medium having stored therein an information processing program that causes a computer having a first memory used by a first calculation resource and a second memory used by a second calculation resource to perform a process including, managing the first memory and the second memory as a single integrated memory; when causing the second calculation resource to execute a target process, predicting a first predicted end time when the target process is executed by a first method in which the process is allocated by exceeding a memory amount of the second memory, and predicting a second predicted end time when the target process is executed by a second method in which the process is allocated with a delay so as not to exceed the memory amount of the second memory; and executing the target process by using the method corresponding to the one of the first method and the second method that provides higher processing performance for the target process, based on the first predicted end time and the second predicted end time.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing system according to an embodiment;

FIG. 2 is a block diagram illustrating a hardware (HW) configuration example of a computer that realizes functions of the information processing system according to the embodiment;

FIG. 3 is a diagram schematically illustrating a process to be processed in the information processing system according to the embodiment;

FIG. 4 is a diagram for explaining memory excess execution and delay execution in the information processing system according to the embodiment;

FIG. 5 is a diagram illustrating a process history in the information processing system according to the embodiment;

FIG. 6 is a diagram illustrating a schedule end time of a target process at the time of delay execution in the information processing system according to the embodiment;

FIG. 7 is a diagram illustrating a schedule end time of a target process in memory excess execution in the information processing system according to the embodiment;

FIG. 8 is a flowchart illustrating processing of the information processing system according to the embodiment;

FIG. 9 is a flowchart for explaining a scheduling technique in the information processing system according to the embodiment; and

FIG. 10 is a flowchart for explaining a scheduling technique in the information processing system according to the embodiment.

### DESCRIPTION OF EMBODIMENTS

However, in the CUDA unified memory, when a larger amount of memory than the memory mounted with the GPU is used, a large amount of page migration occurs due to a page fault in which no page exists in the memory mounted with the GPU, so that the CUDA unified memory falls into a thrashing state, and there is a possibility that the execution speed of the process is greatly reduced.

Hereinafter, embodiments of the present information processing program, information processing apparatus, and information processing method will be described with reference to the drawings. However, the embodiments described below are merely examples, and it is not intended to exclude the application of various modifications and techniques that are not explicitly described in the embodiments. That is, the present embodiment can be variously modified and implemented without departing from the gist thereof. Each drawing is not intended to include only the components illustrated in the drawing, but may include other functions and the like.

### (A) Configuration

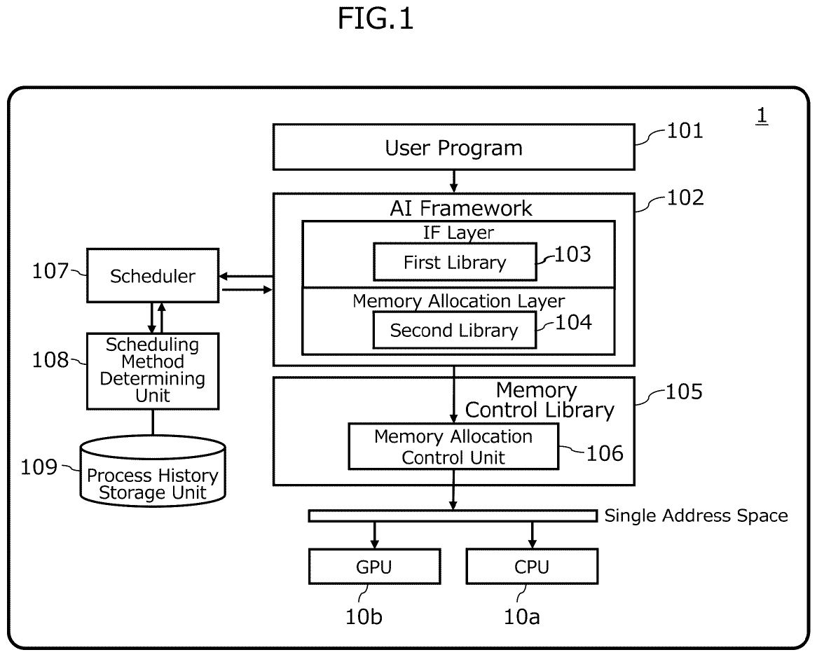

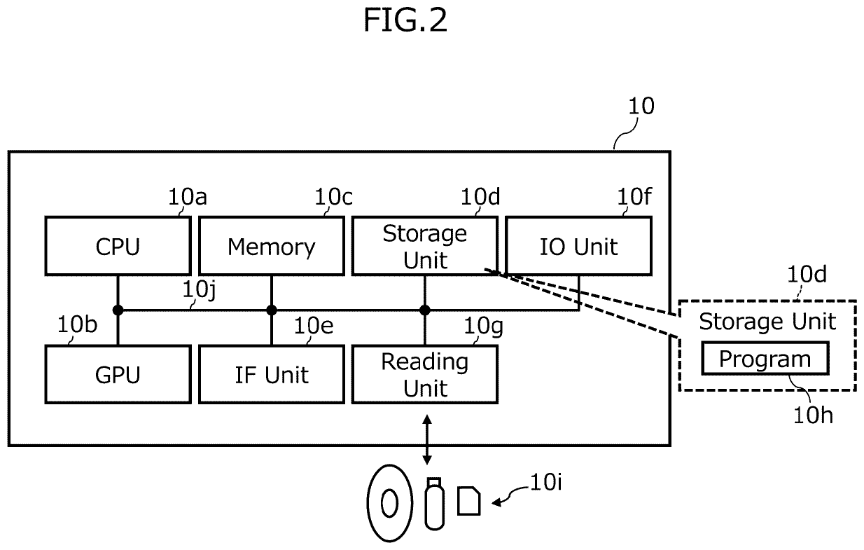

FIG. 1 is a diagram illustrating a schematic configuration of an information processing system 1 according to an embodiment, and FIG. 2 is a block diagram illustrating an example of a hardware (HW) configuration of a computer 10 that realizes the functions of the information processing system 1 according to the embodiment.

### (A-1) Hardware Configuration Example

When a plurality of computers are used as the HW resource for implementing the functions of the information processing system 1, each computer may have the HW configuration illustrated in FIG. 2.

As illustrated in FIG. 2, the computer 10 is an information processing device, and may include, as its HW configuration, for example, one or more (one in the example illustrated in FIG. 2) CPUs 10a, one or more (one in the example illustrated in FIG. 2) GPUs 10b, memory 10c, a storage unit 10d, an interface (IF) unit 10e, an input/output (IO) unit 10f, and a reading unit 10g.

The CPU 10a is an example of an arithmetic processing apparatus that executes various controls and calculations, and is a controller that executes various processing. The CPU 10a may be communicably connected to each block in the computer 10 via a bus 10j. The bus 10j may be a peripheral component interconnect-express (PCIe) bus. Furthermore, the CPU 10a may be a multiprocessor including a plurality of processors, may be a multi-core processor including a plurality of processor cores, or may have a configuration including a plurality of multi-core processors. The CPU 10a is an example of the first calculation resource.

The GPU 10b may be, for example, an accelerator such as a general purpose computing on graphics processing unit (GPGPU). In addition, the GPU 10b may be used to control the screen display on output devices such as monitors within the IO unit 10f. The GPU 10b may have a configuration as an accelerator that executes machine learning processing and inference processing using a machine learning model. Regarding the machine learning processing and the inference processing, the GPU 10b may be said to have higher processing performance than the CPU 10a. The GPU 10b is an example of the second calculation resource. In addition, a video random access memory (VRAM) (not illustrated) is mounted on the GPU 10b. The VRAM of the GPU 10b may be referred to as a GPU memory. The GPU memory is an example of a second memory used by the GPU 10b (second calculation resource).

The CPU 10a and the GPU 10b are calculation resources allocated to a user program 101 to be described later. The CPU 10a is an example of the first calculation resource, and the GPU 10b is an example of the second calculation resource.

The memory 10c is an example of HW that stores information such as various data and programs. Examples of the memory 10c include one or both of a volatile memory such as a dynamic random access memory (DRAM) and a nonvolatile memory such as a persistent memory (PM). The memory 10c is an example of a first memory used by the CPU 10a (first calculation resource). The memory 10c may be referred to as a system memory or a CPU memory.

The storage unit 10d is an example of HW that stores information such as various data and programs. Examples of the storage unit 10d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), and a read only memory (ROM).

The storage unit 10d may store a program 10h (user program 101, information processing program) that realizes all or part of the various functions of the computer 10.

For example, the CPU 10a of the information processing system 1 can realize functions as a user program 101, an AI framework 102, a memory control library 105, a scheduler 107, a scheduling method determining unit 108, and a process history storage unit 109, which will be described later, by developing the program 10h stored in the storage unit 10d in the memory 10c and executing the program.

The IF unit 10e is an example of a communication IF that controls connection and communication between the present computer 10 and another computer. For example, the IF unit 10e may include an adapter that complies with a local area network (LAN) such as Ethernet® or optical communication such as fibre channel (FC). The adapter may support one or both of wireless and wired communication systems. In addition, the program 10h may be downloaded from a network to the computer 10 via the communication IF and stored in the storage unit 10d.

The IO unit 10f may include one or both of an input device and an output device. Examples of the input device include a keyboard, a mouse, and a touch panel. Examples of the output device include a monitor, a projector, and a printer. In addition, the IO unit 10f may include a touch panel or the like in which an input device and an output device are integrated. The output device may be connected to the GPU 10b. The IO unit 10f may be an input device or an output device of another information processing apparatus remotely connected to the computer 10 by a secure shell (SSH) or the like.

The reading unit 10g is an example of a reader that reads information of data and programs recorded on a recording medium 10i. The reading unit 10g may include a connection terminal or device to which the recording medium 10i can be connected or inserted. Examples of the reading unit 10g include an adapter conforming to a universal serial bus (USB) or the like, a drive device that accesses a recording disk, and a card reader that accesses a flash memory such as an SD card. In addition, the program 10h may be stored in the recording medium 10i, and the reading unit 10g may read the program 10h from the recording medium 10i and store the program in the storage unit 10d.

Examples of the recording medium 10i include a non-transitory computer-readable recording medium such as a magnetic/optical disk or a flash memory. Examples of the magnetic/optical disk include a flexible disk, a compact disc (CD), a digital versatile disc (DVD), a Blu-ray disc, and a holographic versatile disc (HVD). Examples of the flash memory include semiconductor memories such as a USB memory and an SD card.

The above-described HW configuration of the computer 10 is an example. Therefore, in the computer 10, an increase or decrease (for example, addition or deletion of an arbitrary block), division, integration in an arbitrary combination for the HWs, addition or deletion of a bus, or the like may be appropriately executed.

### (A-2) Functional Configuration Example

As illustrated in FIG. 1, the information processing system 1 may illustratively include functions as the user program 101, the AI framework 102, the memory control library 105, the scheduler 107, the scheduling method determining unit 108, and the process history storage unit 109. These functions may be implemented by hardware of the computer 10 (see FIG. 2).

The user program 101 may be, for example, a program that realizes a process of executing training (deep learning) of a deep learning model (machine learning model) (not illustrated), and may execute a job related to deep learning. The user program 101 is, for example, a deep learning program.

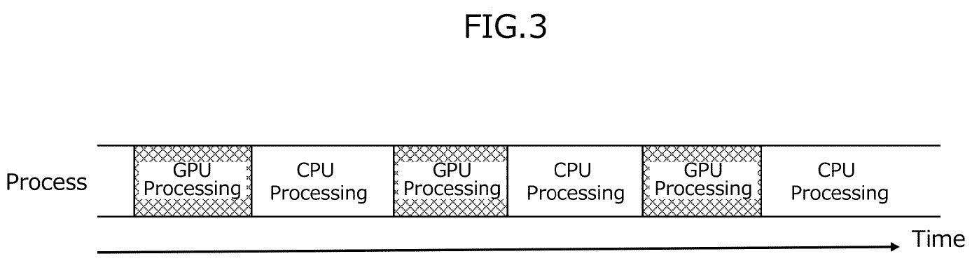

FIG. 3 is a diagram schematically illustrating a process to be processed in the information processing system 1 according to the embodiment.

In AI processing, similar processing is repeatedly executed, as seen in batch processing in learning processing and inference processing on an inference server.

For example, in the processing of deep learning (training phase), pre-processing, machine learning (main processing), and post-processing are repeatedly executed. Furthermore, similarly in the processing of the inference phase, pre-processing for receiving a request and the like, inference processing (main processing), and post-processing are repeatedly executed.

Among these, pre-processing and post-processing may be executed using the CPU 10a, and this processing may be executed using the GPU 10b.

In addition, a series of processing including pre-processing, main processing, and post-processing can be called a job. In the information processing system 1, one user program 101 may execute one process, and a plurality of processes may be executed by executing a plurality of user programs 101. One user program 101 may execute a plurality of processes.

In the present information processing system 1, in the scheduler 107 to be described later, a calculation resource (CPU 10a, GPU 10b) is allocated to each of a plurality of processes, and scheduling for executing a job is executed.

In addition, when the use of the calculation resources ends, the user program 101 may execute an output (release notification) notifying that the calculation resources are released to the scheduler 107 via the AI framework 102. For example, when the user program 101 completes processing using the GPU 10b, the user program transmits a GPU release notification to the scheduler 107 via the AI framework 102. Further, when the user program 101 completes the processing using the CPU 10 a, the user program transmits a CPU release notification to the scheduler 107 via the AI framework 102.

The memory control library 105 is a library that controls data allocation in a single memory address space without distinction between the CPU memory and the GPU memory. The memory control library 105 has a function as a memory allocation control unit 106.

The memory allocation control unit 106 manages the CPU memory and the GPU memory as a single memory without distinction. The memory allocation control unit 106 manages the storage area of the CPU memory and the storage area of the GPU memory as one memory space. The memory allocation control unit 106 implements a function of managing the CPU memory (first memory) and the GPU memory (second memory) as a single integrated memory.

In response to an access request from a second library 104 to be described later, the memory allocation control unit 106 responds to the AI framework 102 with a pointer indicating a storage area in a single memory address space acquired by integrating a storage area memory address space of the CPU memory and a memory address space of the GPU memory. Hereinafter, a memory formed by integrating the CPU memory and the GPU memory as a single memory address space may be referred to as a unified memory.

When the data requested from the AI framework 102 does not exist in the GPU memory, the memory allocation control unit 106 transfers the data from the CPU memory (system memory) to the GPU memory.

The memory control library 105 may be, for example, a CUDA library, and the memory allocation control unit 106 may execute a function as cudaMallocManaged ( ), for example.

The AI framework 102 is a framework that executes processing related to AI. The AI framework 102 includes a first library 103 and a second library 104. The AI framework 102 may execute a function as, for example, PyTorch or TensorFlow.

The first library 103 may output, to the scheduler 107, a switching instruction for switching calculation resources (CPU 10a, GPU 10b) at the time of execution of the user program 101, for example, at the time of transition from the pre-processing to the main processing and at the time of transition from the end of the main processing to the post-processing. The first library 103 transmits a request for GPU resources to the scheduler 107.

For example, the first library 103 may be executed by executing a hook set to a specific GPU processing function in the user program 101. The first library 103 may be incorporated into an IF layer.

The second library 104 executes a process for realizing memory integration in which the storage area of the CPU memory and the storage area of the GPU memory are treated as a single memory address space. The second library 104 replaces the memory allocation processing of the AI framework 102 with the memory allocation control unit 106 of the memory control library 105. The second library 104 secures a memory for the memory allocation processing of the AI framework 102 via the memory allocation control unit 106.

The second library 104 may be incorporated into a memory allocation layer.

For example, by causing the memory allocation control unit 106 to execute memory allocation by the cudaMallocManaged function, the second library 104 can realize processing by the GPU 10b without generating an OOM even when the memory excess occurs.

The information processing system 1 has a function (first scheduling function) of executing delay execution to delay and execute the processing of the GPU 10b in order to avoid a memory excess state in a single memory address space formed by the storage area of the system memory (hereinafter, referred to as CPU memory) used by the CPU 10a and the storage area of the GPU memory possessed by the GPU 10b.

Here, the memory excess state refers to a state in which the memory use exceeds in the GPU memory mounting amount when a new process is input for causing the GPU 10b to execute.

In the delay execution, when a memory excess state occurs in a case where the GPU 10b is caused to execute a new process, input of the new process is made to wait until free space is generated in the memory. That is, in order to avoid the memory excess state, the start of execution of a new process is delayed.

Furthermore, the information processing system 1 also has a function (second scheduling function) of executing memory excess execution of inputting a new process even when a memory excess state occurs when the GPU 10b executes the new process.

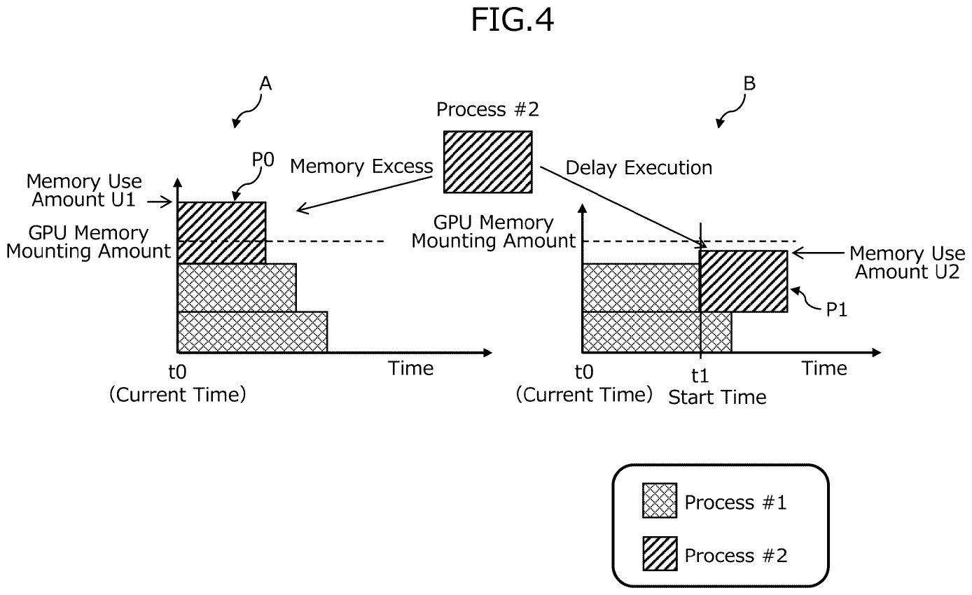

FIG. 4 is a diagram for explaining memory excess execution and delay execution in the information processing system 1 according to the embodiment. A sign A indicates a use state of the memory due to the memory excess execution, and a sign B indicates a use state of the memory due to the delay execution.

FIG. 4 illustrates an example in which the process #1 is being executed at the current time (time t0) and the process #2 is additionally executed in this state.

In the memory excess execution, as indicated by a sign A, the process #2 is executed (immediately executed) at the current time (time t0) even though the memory use amount U1 exceeds the GPU memory mounting amount (see a sign P0).

On the other hand, in the delay execution, as indicated by sign B, at least a part of the processing of the process #1 ends and the memory is released, and the execution of the process #2 is made to wait until time t1 at which the memory use amount U2 does not exceed the GPU memory mounting amount even when the process #2 is additionally executed. That is, after waiting until time t1 at which the memory is not in the memory excess state, process #2 is executed (see sign P1).

As a result, in the delay execution, the GPU 10b can be shared among a plurality of processes without exceeding the GPU memory mounting amount.

The scheduling method determining unit 108 determines a scheduling method by the scheduler 107 described later. Specifically, the scheduling method determining unit 108 determines which one of the delay execution and the memory excess execution is used by scheduler 107 for the process based on the process history of the process by the GPU 10b. The process history of the process by the GPU 10b is stored in the process history storage unit 109.

The process history storage unit 109 stores information (hereinafter, referred to as a process history) indicating a process execution history (execution log) by the GPU 10b. Execution of the process by the GPU 10b may be referred to as GPU processing.

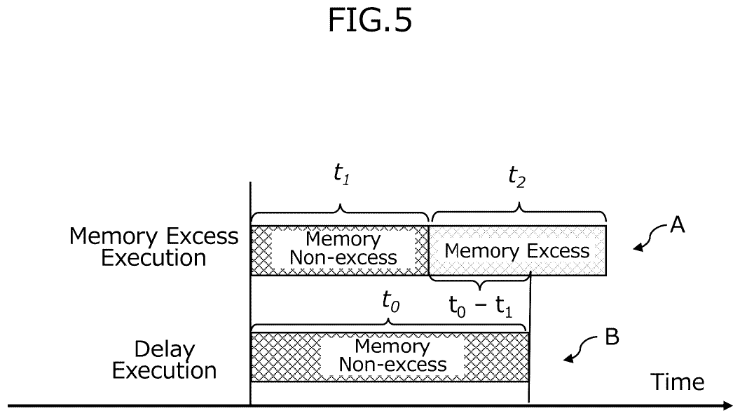

FIG. 5 is a diagram illustrating a process history in the information processing system 1 according to the embodiment.

In FIG. 5, an arrow B indicates the execution time to of the GPU processing when the delay execution is executed. Since the memory excess state does not occur at the time of executing the delay execution, the execution time of the GPU processing at the time of executing the delay execution may be referred to as “memory non-excess time”.

In FIG. 5, an arrow A indicates the execution time of the GPU processing at the time of executing the memory excess execution. When the memory excess is executed, the state is basically in the memory excess state, but for example, when another process executed in parallel ends, the state may not be in the memory excess state. The execution time of the GPU processing in the memory excess state may be referred to as “memory excess time”.

As illustrated in FIG. 5, the execution time of the GPU processing at the time of executing the memory excess execution can be indicated by a sum (t₁+t₂) of the memory excess time t₂ and the memory non-excess time t₁.

When the memory excess occurs, the scheduling method determining unit 108 calculates the delay rate a based on the following Formula (1).

$$Delay rate α = {t}_{2} / ( {t}_{0} - {t}_{1} ) \qquad ( 1 )$$

The process history stored in the process history storage unit 109 may include the execution time (t₁+t₂) of the GPU processing at the time of executing the memory excess execution, the execution time to of the GPU processing at the time of executing the delay execution, the GPU memory amount M used by the process during the GPU processing, and the delay rate a when the memory excess occurs, which are acquired as described above. In addition, the process history storage unit 109 stores the process history for each process identification (PID: process ID).

The scheduling method determining unit 108 predicts end times of GPU processing of all processes in execution when a process to be scheduled (hereinafter, referred to as a target process) is processed by memory excess execution. The predicted end time of the GPU processing of all processes in execution may be referred to as a predicted end time.

When causing the GPU 10b (second calculation resource) to execute the target process, the scheduling method determining unit 108 predicts the first predicted end time when the target process is executed by the first method (memory excess execution) in which the excess of the memory amount of the GPU memory (GPU memory mounting amount) occurs and the process is allocated.

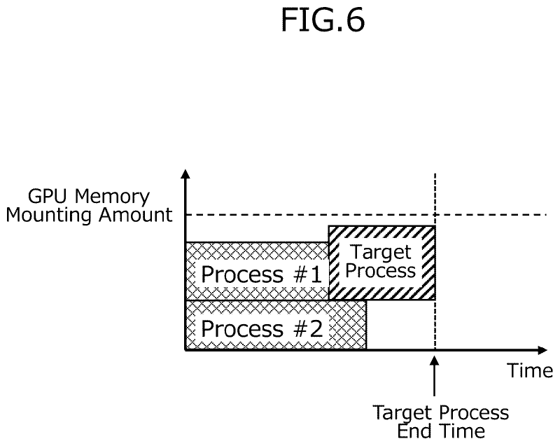

FIG. 6 is a diagram illustrating a schedule end time of a target process at the time of execution of a delay in the information processing system 1 according to an embodiment. In FIG. 6, the vertical axis indicates the use amount of the GPU memory (GPU use memory amount), and the horizontal axis indicates the elapsed time.

Regarding the delay execution, based on the GPU use memory amount and the schedule end time of the currently executing process (in the example illustrated in FIG. 6, processes #1 and #2) and the GPU use memory amount of the target process, the scheduling method determining unit 108 executes scheduling so that the target process is executed at an earliest executable time without causing memory excess.

For example, the scheduling method determining unit 108 may determine the predicted end time of the target process by adding the execution time of the target process to the start time of the target process. The scheduling method determining unit 108 similarly acquires the predicted end time of the GPU processing of all the processes being executed based on the scheduling result.

The scheduling method determining unit 108 predicts the second predicted end time when the target process is executed by the second method (delay execution) of delaying and allocating the process not to exceed the memory amount (memory mounting amount) of the GPU memory.

In addition, the scheduling method determining unit 108 acquires the predicted end time of the GPU processing of all the processes being executed in the case of processing in the memory excess execution based on the scheduling result by the scheduler 107.

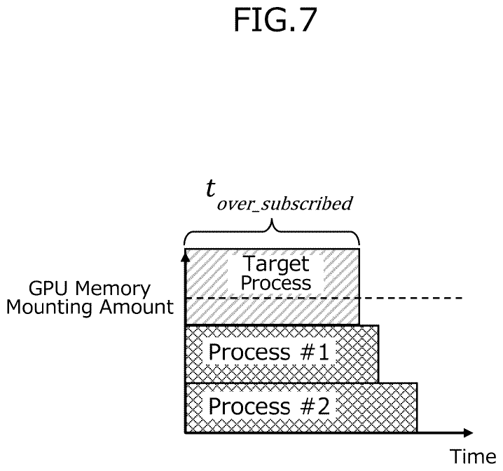

FIG. 7 is a diagram illustrating a schedule end time of the target process in the memory excess execution in the information processing system 1 according to the embodiment. Also in FIG. 7, the vertical axis indicates the use amount of the GPU memory (GPU use memory amount), and the horizontal axis indicates the elapsed time.

In the example illustrated in FIG. 7, the execution time t_{over_subscribed} of the target process corresponds to the execution section where memory excess occurs. The scheduling method determining unit 108 calculates the time t_{over_subscribed} needed for the execution section in which the memory excess occurs using the following Formula (2). Here, MP is the GPU use memory amount by the GPU processing of the process p, α^{p} is the delay rate of the process p, and t_{end}^{p} is the schedule end time of the process p.

In addition, in Formula (2), minₚ (t_{end}^{p}−t_{now}) may indicate the time until the end time of the process that first ends, and may indicate the time in the state before the delay occurs. Furthermore, in Formula (2), in view of the fact that the larger the memory amount used by the GPU, the greater the influence on the delay, it can be said that a coefficient using the memory amount used by the GPU is multiplied by minₚ (t_{end}^{p}−t_{now}).

$${t}_{over\_subscribed} = {\sum }_{p} ( {α}^{p} {M}^{p} / {\sum }_{p} {M}^{p} ) {min}_{p} ( {t}_{end}^{p} - {t}_{now} ) \qquad ( 2 )$$

By using the above Formula (2), the scheduling method determining unit 108 acquires the influence of the thrashing in consideration of the memory use that is already being executed in the case of processing the process by the memory excess execution.

Then, the scheduling method determining unit 108 can calculate the schedule end time of each process extended due to the occurrence of the thrashing by adding the remaining execution time of each job to t_{over_subscribed} acquired by using Formula (2).

The scheduling method determining unit 108 may acquire the end time of the process p by using the following Formula (3).

$$End time {t}_{p} = {t}_{over\_subscribed} + {t}_{e n {d}^{P}} - {min}_{p} ( {t}_{e n {d}^{p}} - {t}_{now} ) + {t}_{now} \qquad ( 3 )$$

Then, the scheduling method determining unit 108 determines, as the scheduling, one of the memory excess execution and the delay execution with better performance based on a predefined performance criteria.

The performance criteria may be, for example, the sum of the execution times of all the GPU processing or the time when the last process ends. For example, when throughput is emphasized as performance, it is desirable to use the sum of the execution times of all the GPU processing as the performance criteria. In addition, when the latency is emphasized as the performance, it is desirable to use the time when the last process ends as the performance criteria. In addition, values other than these may be used as the performance criteria.

Based on the first predicted end time and the second predicted end time, the scheduling method determining unit 108 executes the target process by using a method corresponding to a process with higher processing performance for the target process out of the memory excess execution (first method) and the delay execution (second method).

The scheduler 107 allocates a calculation resource (GPU 10b) to the user program 101. In addition, the scheduler 107 manages a job allocation state for calculation resources in the present information processing system 1. The scheduler 107 manages an allocation state of the GPU 10b.

The scheduler 107 allocates a process to the GPU 10b by using the scheduling (delay execution or memory excess execution) determined by the scheduling method determining unit 108.

For example, in a case where a process is executed by the GPU 10b to cause a memory excess state, when a process is allocated to the GPU 10b by memory excess execution, the scheduler 107 executes scheduling to cause the GPU 10b to immediately execute the process. In addition, when a process is allocated to the GPU 10b by delay execution, the scheduler 107 causes execution of the process to wait until the GPU memory use amount does not cause the excess of the GPU memory mounting amount. Then, the scheduler 107 executes scheduling such that the process starts on the GPU 10b at the earliest time within a range in which the GPU memory use does not exceed the GPU memory mounting amount.

The scheduler 107 may instruct (respond) the execution of the process by the GPU 10b to the AI framework 102 at a time determined by scheduling, for example.

The scheduler 107 may manage the allocation state of the GPU 10b using, for example, a resource table (not illustrated). In the resource table, for example, when a job is allocated to the GPU 10b, information for specifying an allocated process may be stored in association with information for specifying the GPU 10b. Furthermore, when no job is allocated to the GPU 10b, information indicating that the GPU 10b is in an empty state may be stored in association with information specifying the GPU 10b in the resource table.

When a GPU allocation request is transmitted from the AI framework 102, the scheduler 107 checks whether the GPU 10b can be allocated to this process. When the process can be allocated to the GPU 10b, the scheduler 107 allocates the GPU 10b to the process.

### (B) Operation

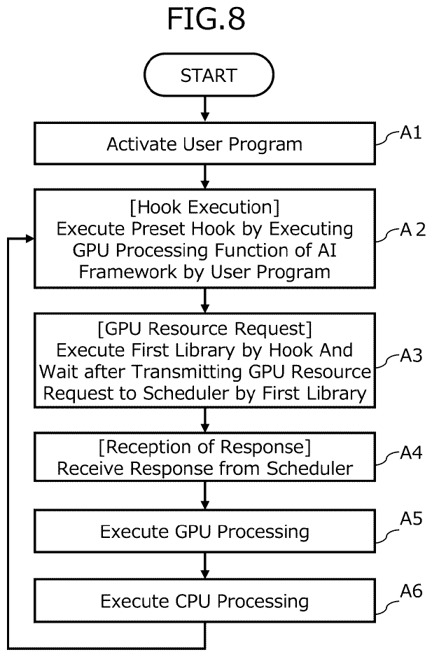

The processing of the information processing system 1 according to the embodiment configured as described above will be described with reference to the flowchart (steps A1 to A6) illustrated in FIG. 8.

In step A1, the user program 101 is activated. When the user program 101 executes the GPU processing function of the AI framework 102, a hook preset to the GPU processing function is executed (step A2).

With this hook, the first library 103 is executed in the AI framework 102. The first library 103 waits after transmitting the GPU resource request to the scheduler 107 (step A3).

The AI framework 102 receives a response to the GPU resource request from the scheduler 107 (step A4) and executes GPU processing (step A5). In the GPU processing, the second library 104 causes the memory allocation control unit 106 to execute, for example, the cudaMallocManaged function to execute memory allocation. The memory allocation control unit 106 responds to the AI framework 102 with a pointer of the unified memory address space.

The AI framework 102 accesses memory using pointers in the unified memory address space. When there is no data to be accessed in the GPU memory, the data is transferred from the system memory.

In step A6, CPU processing (for example, post-processing or pre-processing of the next process) is executed. Thereafter, the process returns to step SA2.

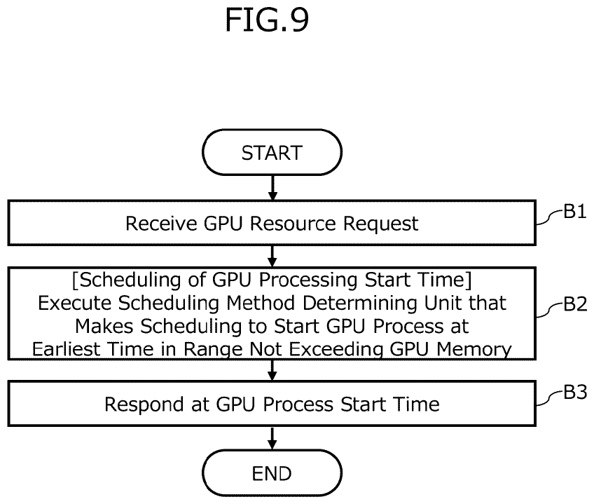

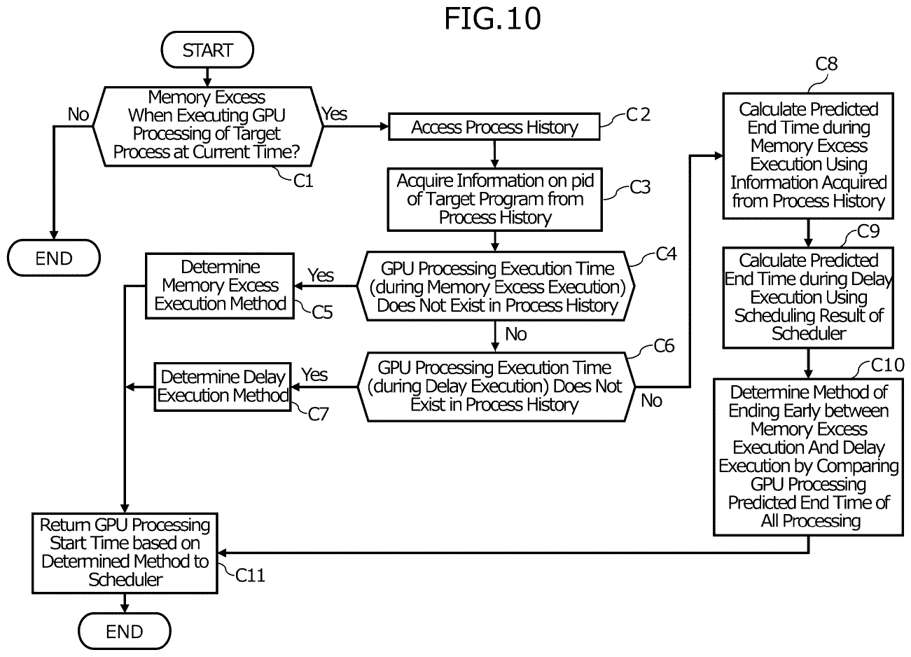

Next, a scheduling method in the information processing system 1 according to the embodiment will be described with reference to flowcharts illustrated in FIGS. 9 and 10. FIG. 9 is a flowchart (steps B1 to B3) for explaining the processing of the scheduler 107, and FIG. 10 is a flowchart (steps C1 to C11) for explaining the processing of the scheduling method determining unit 108.

Upon receiving the GPU resource request from the AI framework 102 (step B1 of FIG. 9), the scheduler 107 schedules the start time of the GPU processing (step B2 of FIG. 9). The scheduler 107 executes scheduling so that the GPU processing starts at the earliest time within a range in which the excess of the GPU memory does not occur. The scheduler 107 activates the scheduling method determining unit 108.

The scheduling method determining unit 108 checks whether memory excess occurs when the execution of the GPU processing of the target process starts at the current time (step C1 in FIG. 10). As a result of the checking process, when the memory excess does not occur (see No route in step C1), the process as the scheduling method determining unit 108 ends.

Here, when the memory excess does not occur even when the execution of the GPU processing of the target process starts at the current time, the start time of the GPU processing scheduled by the scheduler 107 is the current time.

At the start time of the GPU processing, the scheduler 107 responds to the AI framework 102 with an execution start instruction of the process (step B3 in FIG. 9). That is, the scheduler 107 instructs the GPU 10b to immediately start executing the process.

On the other hand, as a result of the checking process in step C1, when the memory excess occurs (see Yes route in step C1), the process proceeds to step C2 in FIG. 10.

In step C2, the scheduling method determining unit 108 accesses the process history stored in the process history storage unit 109.

In step C3 of FIG. 10, the scheduling method determining unit 108 acquires information about the PID of the target program (target process) from the process history.

The acquired information may include the execution time (t₁+t₂) of the GPU processing at the time of executing the memory excess execution, the execution time to of the GPU processing at the time of executing the delay execution, the GPU memory amount M in which the process is used during the GPU processing, and the delay rate a when the memory excess occurs.

In step C4 of FIG. 10, the scheduling method determining unit 108 checks whether there is an execution time of the GPU processing at the time of executing the memory excess execution corresponding to the PID of the target process in the process history.

When there is no execution time of the GPU processing when the memory excess execution is executed in the process history (see Yes route in step C4), the process proceeds to step C5 of FIG. 10. In step C5, the scheduling method determining unit 108 determines the memory excess execution as the scheduling method. Thereafter, the process proceeds to step C11 in FIG. 10.

When the execution time of the GPU processing at the time of executing the memory excess execution exists in the process history (see No route in step C4), the process proceeds to step C6 of FIG. 10.

In step C6 of FIG. 10, the scheduling method determining unit 108 checks whether there is an execution time of the GPU processing at the time of executing the delay execution corresponding to the PID of the target process in the process history.

When there is no execution time of the GPU processing at the time of execution of the delay (see Yes route in step C6) in the process history, the process proceeds to step C7 of FIG. 10. In step C7, the scheduling method determining unit 108 determines delay execution as the scheduling method. Thereafter, the process proceeds to step C11 in FIG. 10.

When the execution time of the GPU processing at the time of executing the delay execution exists in the process history (see No route in step C6), the process proceeds to step C8 of FIG. 10.

In step C8, the scheduling method determining unit 108 uses the information acquired from the process history to calculate the predicted end time when the processing is executed in the memory excess execution.

In step C9 of FIG. 10, the scheduling method determining unit 108 uses the scheduling result of the scheduler 107 to calculate the predicted end time in the case of executing processing by delay execution.

In step C10 of FIG. 10, the scheduling method determining unit 108 compares the predicted GPU processing end times of all processes, and determines a method of ending early between the memory excess execution and the delay execution.

Thereafter, in step C11, the scheduling method determining unit 108 returns the GPU processing start time based on the determined method to the scheduler 107. Thereafter, the processing ends.

### (C) Effects

As described above, according to the information processing system 1 as an example of the embodiment, the memory allocation control unit 106 manages the CPU memory and the GPU memory as a single integrated memory. This can avoid the occurrence of OOM.

Furthermore, when causing the GPU 10b to execute the target process, the scheduling method determining unit 108 predicts the predicted end time (first predicted end time) of the GPU processing when the target process is executed by the memory excess execution, and the predicted end time (second predicted end time) of the GPU processing when the target process is executed without causing the memory excess execution.

Then, the scheduling method determining unit 108 specifies (determines) a method corresponding to one of the memory excess execution and the delay execution having higher processing performance for the target process, and the scheduler 107 executes scheduling using the determined method. As a result, the time needed for processing the target process can be shortened, and the throughput can be improved. That is, performance of processing the process can be improved.

In addition, since the scheduling method determining unit 108 specifies (determines), for each process, a method corresponding to one of the memory excess execution and the delay execution having higher processing performance for the target process, each of the plurality of processes can be executed by an advantageous method, and the process execution of the entire system can be speeded up.

In addition, the scheduling method determining unit 108 executes scheduling to cause the target process to be executed at the earliest executable time without exceeding the GPU memory mounting amount and hence acquires the predicted end time of the GPU processing of all the processes being executed in the case of processing by delay execution.

As a result, it is possible to accurately and easily acquire the predicted end times of the GPU processing of all the processes being executed in the case of processing by delay execution.

Furthermore, the scheduling method determining unit 108 acquires the predicted end time of the GPU processing of all the processes being executed in the case of processing in the memory excess execution based on the execution time of the processing by the GPU 10b at the time of executing the memory excess execution, the execution time of the processing by the GPU 10b at the time of executing the delay execution, and the use amount of the integrated memory used by the process for the processing by the GPU 10b.

As a result, it is possible to accurately and easily acquire the predicted end time of the GPU processing of all the processes being executed in the case of processing by the memory excess execution.

The scheduling method determining unit 108 determines, as a scheduling method, one of the memory excess execution and the delay execution having better performance based on a performance criteria defined in advance. Thereby, the process can be processed more effectively, and processing performance can be improved.

### (D) Others

The disclosed technology is not limited to the above-described embodiment, and various modifications can be made without departing from the gist of the present embodiment.

For example, in the above-described embodiment, an example in which the computer 10 includes one CPU 10a has been described, but the present embodiment is not limited thereto, and the computer 10 may include two or more CPUs 10a. Similarly, in the above-described embodiment, an example in which the computer 10 includes one GPU 10b is illustrated, but the present embodiment is not limited thereto, and the computer 10 may include two or more GPUs 10b.

In addition, in the embodiment described above, an example in which the memory control library 105 is a CUDA library and that the memory allocation control unit 106 may execute a function as cudaMallocManaged( ) are described, but the present embodiment is not limited thereto. The functions of the memory control library 105 and the memory allocation control unit 106 may be implemented using other known methods.

Furthermore, according to the disclosure described above, the present embodiment can be implemented and manufactured by those skilled in the art.

In accordance with the embodiment, the time taken to execute the process can be reduced.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer having a first memory used by a first calculation resource and a second memory used by a second calculation resource to perform a process comprising,
managing the first memory and the second memory as a single integrated memory;
when causing the second calculation resource to execute a target process,
predicting a first predicted end time when the target process is executed by a first method in which the process is allocated by exceeding a memory amount of the second memory, and predicting a second predicted end time when the target process is executed by a second method in which the process is allocated with a delay so as not to exceed the memory amount of the second memory; and
executing the target process by using the method corresponding to the one of the first method and the second method that provides higher processing performance for the target process, based on the first predicted end time and the second predicted end time.

2. The non-transitory computer-readable recording medium having stored therein the information processing program according to claim 1,
wherein in the processing of predicting the second predicted end time, the first predicted end time is acquired by scheduling the target process to be executed at an earliest executable time without exceeding the memory amount of the second memory.

3. The non-transitory computer-readable recording medium having stored therein the information processing program according to claim 1,
wherein in the processing of predicting the first predicted end time, the first predicted end time is calculated based on an execution time of processing by the second calculation resource when the first method is implemented, an execution time of processing by the second calculation resource when the second method is implemented, and a use amount of the integrated memory used by a process for processing by the second calculation resource.

4. An information processing apparatus comprising: a first memory used by a first calculation resource; a second memory used by a second calculation resource; and a processor connected to the first memory and the second memory, the processor configured to execute a process comprising:
managing the first memory and the second memory as a single integrated memory;
when causing the second calculation resource to execute a target process,
predicting a first predicted end time when the target process is executed by a first method in which the process is allocated by exceeding a memory amount of the second memory and predicting a second predicted end time when the target process is executed by a second method in which the process is allocated with a delay so as not to exceed the memory amount of the second memory; and
executing the target process by using the method corresponding to the one of the first method and the second method that provides higher processing performance for the target process, based on the first predicted end time and the second predicted end time.

5. The information processing apparatus according to claim 4,
wherein in the processing of predicting the second predicted end time, the processor
acquires the first predicted end time by scheduling the target process to be executed at an earliest executable time without exceeding a memory amount of the second memory.

6. The information processing apparatus according to claim 4,
wherein in the processing of predicting the first predicted end time, the processor calculates the second predicted end time based on an execution time of processing by the second calculation resource when the first method is implemented, an execution time of processing by the second calculation resource when the second method is implemented, and a use amount of the integrated memory used by the process for processing by the second calculation resource.

7. An information processing method of causing a computer having a first memory used by a first calculation resource and a second memory used by a second calculation resource to execute a process, the method comprising:
managing the first memory and the second memory as a single integrated memory;
when causing the second calculation resource to execute a target process,
predicting a first predicted end time when the target process is executed by a first method in which the process is allocated by exceeding a memory amount of the second memory and predicting a second predicted end time when the target process is executed by a second method in which the process is allocated with a delay so as not to exceed the memory amount of the second memory; and
executing the target process by using the method corresponding to the one of the first method and the second method that provides higher processing performance for the target process, based on the first predicted end time and the second predicted end time.

8. The information processing method according to claim 7,
wherein in the processing of predicting the second predicted end time, the first predicted end time is acquired by scheduling the target process to be executed at an earliest executable time without exceeding the memory amount of the second memory.

9. The information processing method according to claim 7,
wherein in the processing of predicting the first predicted end time, the second predicted end time is calculated based on an execution time of processing by the second calculation resource when the first method is implemented, an execution time of processing by the second calculation resource when the second method is implemented, and a use amount of the integrated memory used by a process for processing by the second calculation resource.
